(19) United States
(12) Patent Application Publication
(10) Pub. No.: US 2018/0114022 A1
(43) Pub. Date: Apr. 26, 2018

(54) PROTECTED LOADING OF A MODULE

(71) Applicant: Hewlett Packard Enterprise Development LP, Houston, TX (US)

(72) Inventors: Simon Zuckerbraun, Chicago, IL (US); Abdul Aziz Hariri, Montreal (CA); Brian Thomas Gorenc, Austin, TX (US)

(21) Appl. No.: 15/571,326

(22) PCT Filed: Jun. 18, 2015
(86) PCT No.: PCT/US2015/036508

§ 371 Date: Nov. 2, 2017

(51) Int. Cl. G06F 21/56; G06F 21/55

(52) U.S. Cl. CPC G06F 21/566; G06F 2221/034; G06F 21/552

(57) ABSTRACT

In response to a request to load a module, it is determined whether the number of available locations in an address space for randomized loading of the module exceeds a specified threshold. In response to determining that the number of available locations does not exceed the specified threshold, the request to load the module is rejected.

### BACKGROUND

A computer system can be subject to attack by unauthorized entities such as malware (e.g. viruses, worms, etc.), or other code that is not authorized to perform specific actions in the computer system. Various protection mechanisms have been implemented in computer systems to protect the computer systems from different types of attacks. Such protection mechanisms can include malware protection applications (e.g. anti-virus applications, spyware applications, etc.), protection mechanisms included in operating systems or other code in the computer systems, and so forth.

### BRIEF DESCRIPTION OF THE DRAWINGS

Some implementations of the present disclosure are described with respect to the following figures.

FIGS. 1 and 2 are block diagrams of example computer systems that provide protected loading of an executable module, according to some implementations.

FIG. 3 is a flow diagram of an example process for protected loading of an executable module, according to some implementations.

FIGS. 4 and 5 are flow diagrams of example processes for protected loading of an executable module, according to further implementations.

FIG. 6 is a block diagram of an example system that provides protected loading of an executable module, according to some implementations.

### DETAILED DESCRIPTION

Applications can execute in a computer system. Examples of computer systems can include a desktop computer, a notebook computer, a tablet computer, a smartphone, a wearable device, a game appliance, and so forth. Examples of applications can include a web browser, a script, a word processing application, a spreadsheet application, and so forth. More generally, an application can include a program made up of machine-readable instructions.

An instance of the application that is executed can be referred to as a process (sometimes also referred to as a thread). During operation, the process when executed by a hardware processor(s) can cause the hardware processor(s) to request loading of an executable module into a storage medium, which can be a memory, a buffer, or any other type of storage medium. A hardware processor can refer to a microprocessor, a core of a microprocessor, a microcontroller, an application specific integrated circuit, a programmable gate array, or any other programmable hardware. As an example, the executable module can include a software library, which contains machine-readable instructions that can be invoked to perform specified actions. A software library can include an interface by which a process can invoke the library. In other examples, an executable module can include other types of code that can be invoked in a computer system. More generally, an executable module can refer to a collection of machine-readable instructions. Loading an executable module into a storage medium includes writing machine-readable instructions of the executable module into the storage medium.

The storage medium into which the executable module can be loaded can have an address space. The address space can include addresses referring to storage regions of the storage medium. Some of the storage regions of the storage medium may be occupied, while other storage regions of the storage medium are available to load content, including an executable module. A storage region that is available to load content can be referred to as “free storage region.”

An address in the address space can refer to a start of a respective storage region in the storage medium. In some examples, the addresses can be virtual addresses. Virtual addresses are part of a virtual address space that an operating system (OS) of a computer system makes available to processes that execute in the computer system. During operation, a virtual address is translated into a physical address, with the physical address used to actually store or retrieve information in a respective storage region.

To protect against attacks by attackers, such as malware or other types of unauthorized entities, an OS or other code in a computer system can implement address space layout randomization (ASLR) mitigation. ASLR mitigation is a storage-protection technique to guard against an attack by randomizing a storage location at which an executable module can be loaded into a storage medium. Randomizing a storage location can refer to randomly selecting from among multiple storage regions into which the executable module can be loaded. A goal of ASLR is to introduce randomness in the selection of addresses that are used by a process for loading executable modules and other information.

To defeat ASLR mitigation, an attacker can apply artificial storage pressure by consuming storage regions of a storage medium, and then deallocating a storage region whose address and size is known to a process. The address and size of a given storage region is known to the process if the address and size were previously communicated to the process, such as by an OS.

An attacker can consume a storage region by writing content into the storage region, such that the storage region becomes used and is no longer available to store other information. Deallocating a storage region can refer to removing the content from the storage region so that the deallocated storage region becomes available again for writing other content.

The loading of an executable module at the deallocated storage region can then be performed so that the executable module is made available to the process. The executable module is made available to the process if the process can invoke the executable module to perform a task. The executable module is likely to load at the deallocated storage region because there is no other free storage region or there is a relatively small number of free storage regions (since the remaining free storage regions have been consumed by the attacker). At this point, ASLR mitigation has been defeated, since there may not be a sufficient number of storage regions from which random selection can be made according to ASLR mitigation.

In accordance with some implementations of the present disclosure, protection techniques or mechanisms are provided to provide entropy-dependent loading of an executable module into an address space. The protection techniques or mechanisms according to some implementations are able to protect against an attack that seeks to defeat ASLR mitigation. With entropy-dependent loading of an executable module, an entropy check is first performed in response to an attempt to load an ASLR-enabled executable module into a process. An ASLR-enabled executable module refers to an executable module whose loading is subject to ASLR mitigation.

If the entropy check determines that an entropy condition is not satisfied, then the loading of the executable module fails. The loading of the executable module into the address space is allowed only in response to the entropy check determining that the entropy condition has been satisfied.

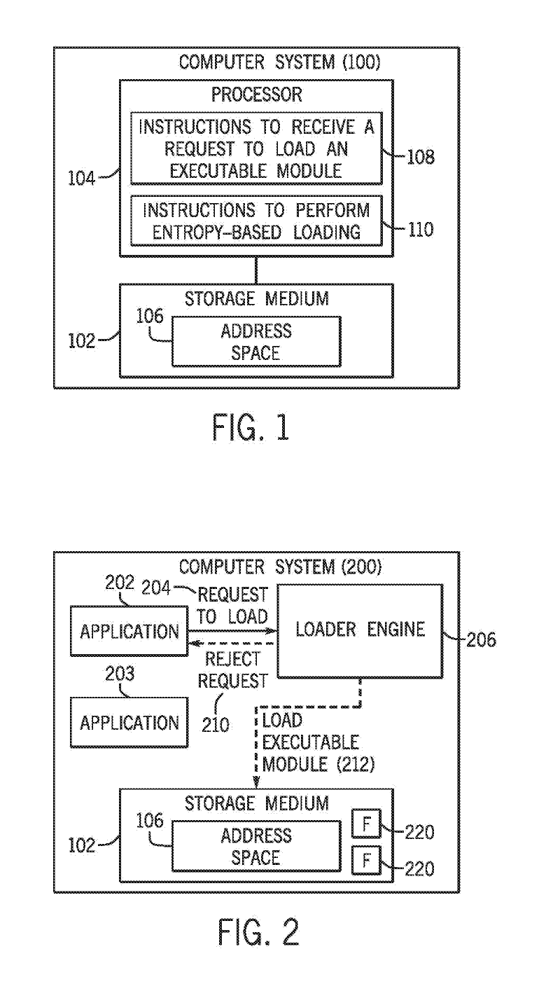

FIG. 1 is a block diagram of an example computer system 100 that includes a storage medium 102 and one or multiple processors 104. A processor can include a microprocessor, a microcontroller, a physical processor module or subsystem, a programmable integrated circuit, a programmable gate array, or another physical control or computing device. A computer system can refer to one computer or an arrangement of multiple computers. The storage medium 102 can include a memory, a buffer, or any other type of storage medium. The storage medium has an address space 106 that includes addresses referring to storage regions in the storage medium 102. The processor 104 can execute machine-readable instructions, including instructions 108 to receive a request to load an executable module and instructions 110 to perform entropy-based loading.

The entropy-based loading performed by the instructions 110 when executed by a hardware processor(s) can include the following tasks. The entropy-based loading performs entropy checking to determine whether the number of addresses of the address space 106 available to load the executable module satisfies an entropy condition. The entropy condition is satisfied responsive to the number of the addresses available to load the executable module exceeding a specified threshold; on the other hand, the entropy condition is not satisfied responsive to the number of the addresses available to load the executable module not exceeding the specified threshold.

The specified threshold can be statically set or dynamically set. The specified threshold can be input by a user (e.g. an administrator), can be configured into an OS or other code in the computer system 100 (e.g. such as by setting the value of the specified threshold in a configuration file), or can be entered using a different technique. The specified threshold can vary for different requesters that are able to request loading of executable module to the address space. For example, for a first requester, the specified threshold can be set to a first value. For a second requester, the specified threshold can be set to a second, different value. The different specified thresholds can be entered by a user (e.g. an administrator), can be set in a configuration file, or can be entered using a different technique.

The entropy-based loading performs different actions depending upon whether the number of available addresses satisfies the entropy condition. The number of available addresses can be tracked by an OS. The OS is the entity that processes requests to allocate regions of address space. As regions of the address space are consumed, the OS can indicate those regions of address space as occupied and no longer available.

In response to determining that the number of available addresses satisfy the entropy condition, the entropy-based loading loads the executable module at a selected address of the available addresses. In some examples, the selected address is a randomly selected address, such on randomly selected using an ASLR mitigation technique.

In response to determining that the number of available addresses does not satisfy the entropy condition, the request to load the executable module is rejected. Rejecting the request can be performed by returning an error or some other indication that the request cannot be performed.

FIG. 2 is a block diagram of an example computer system 200 according to further implementations. The computer system 200 includes an application 202 that can execute in the computer system 200. The application 202 can be, for example, a web browser. In other examples, the application 202 can be a different program. More generally, the application 202 is an example of a requester that is able to request the loading of an executable module into the storage medium 102.

The application 202 (or more specifically, a process that is an executed instance of the application 202) when executed by a hardware processor(s) can cause the hardware processor(s) to send to a loader engine 206, a request (204) to load an executable module. The loader engine 206 can be implemented as a combination of hardware (e.g. one or multiple hardware processors) and programming (implemented as machine-readable instructions) that causes the hardware to perform programmed tasks. The loader engine 206 can include a part of an OS, such as a kernel of the OS. Alternatively, the loader engine 206 can include shim code (or more generally, application code) that includes machine-readable instructions that are separate from the OS. A shim code can refer to a code that when executed by a hardware processor(s) can cause the hardware processor(s) to intercept a request or message that is targeted to a different entity.

The loader engine 206 responds to the request (204) to load the executable module by performing the entropy-based loading tasks discussed above.

If the loader engine 206 determines that the number of available addresses of the address space 106 associated with the storage medium 102 does not satisfy the entropy condition, then the loader engine 206 rejects the request to load (210). The rejecting of the request to load can be indicated by sending an error or other indication of failure to the application 202.

On the other hand, if the loader engine 206 determines that the number of available addresses satisfies the entropy condition, the loader engine 206 loads the executable module (212) to a selected storage region in the storage medium 102. The storage region into which the executable module is loaded can be randomly selected, such as according to an ASLR mitigation technique. Loading the executable module to the selected storage region can include writing machine-readable instructions of the executable module to the selected storage region.

In some implementations, entropy-based loading of an executable module can be performed in response to a request from a first requester (e.g. application 202). However, entropy-based loading of an executable module can be disabled for a second requester (e.g. application 203 in FIG. 2). If entropy-based loading is enabled for a first requester, the a request from the first requester to load an executable module in the storage medium 102 would be subject to the entropy checking before loading of the executable module is allowed. On the other hand, if entropy-based loading is disabled for a second requester, then a request to load an executable module from the second requester would be performed by the loader engine 206 without first performing the entropy checking.

Entropy-based loading can be enabled for the first requester (e.g. application 202) by setting a flag 220 corresponding to the first requester to a first value. Entropy-based loading can be disabled for the second requester (e.g. application 203) by setting a flag 222 corresponding to the second requester to a second, different value. The flags 220 and 222 can be stored in the storage medium 102. The flags 220 and 222 can be set to respective values in response to request form a user, or alternatively, the flags can be set by another entity.

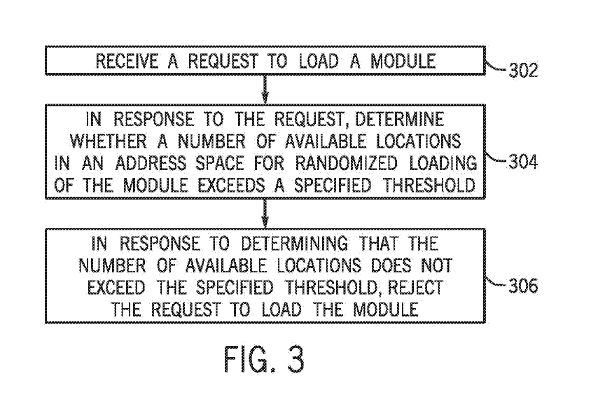

FIG. 3 is a flow diagram of an example procedure that can be performed by a system, such as by the computer system 100 of FIG. 1 or the computer system 200 of FIG. 2. The system receives (at 302) a request to load a module (e.g. an executable module as discussed above).

In response to the request, the system determines (at 304) whether a number of available locations in an address space for randomized loading (such as ASLR randomized loading) of the module exceeds a specified threshold. The number of available locations in the address space can correspond to the number of available addresses as discussed above. In response to determining that the number of available locations does not exceed the specified threshold, the system rejects (at 306) the request to load the module.

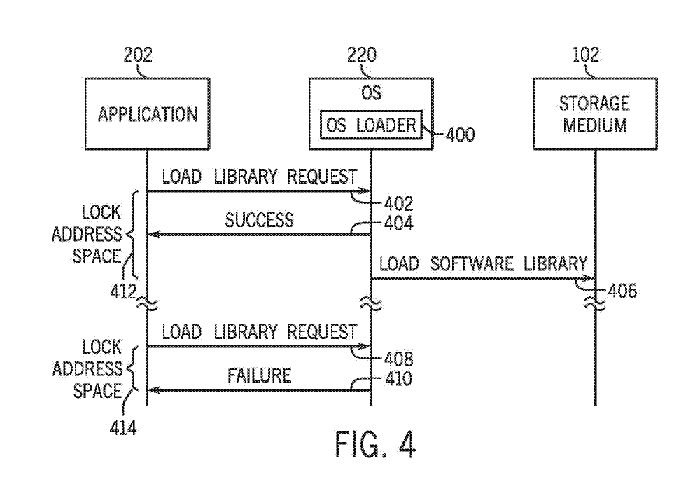

FIG. 4 is a message flow diagram of an example procedure that involves the application 202 and a loader 400 that is part of an OS 220. In the example of FIG. 4, the loader 400 is referred to as an “OS loader 400,” The OS loader 400 can be part of the loader engine 206 of FIG. 2. More generally, the OS loader 400 when executed by a hardware processor(s) can cause the hardware processor(s) to perform certain tasks. The application 202 (and more specifically a process that s an executed instance of the application 202) when executed by a hardware processor(s) causes the hardware processor(s) to submit a load library request (402) to the OS loader 400. The load library request is to load a software library into the storage medium 102. In response to the load library request (402), the OS loader 400 when executed by a hardware processor(s) causes the hardware processor(s) to determine whether the number of addresses available to load the software library satisfies the entropy condition. If so, the OS loader 400 when executed by a hardware processor(s) causes the hardware processor(s) to send a success indication (404) to the application 202, and when executed by a hardware processor(s) causes the hardware processor(s) to load (at 406) the requested software library to a randomly selected available address in the storage medium 102.

At a later time, the application 202 when executed by a hardware processor(s) causes the hardware processor(s) to submit another load library request (408) to load a software library (which can be the same as or different from the software library that is the subject of the load library request 402). In response to the load library request (408), the OS loader 400 when executed by a hardware processor(s) causes the hardware processor(s) to determine whether the number of addresses available to load the software library satisfies the entropy condition. In response to determining that the number of available addresses does not satisfy the entropy condition, the OS loader 400 when executed by a hardware processor(s) causes the hardware processor(s) to return a failure indication (410) to the application 202, and decline to load the requested software library.

In some implementations, a locking mechanism is provided to prevent any changes during a time interval (e.g. time interval 412 or 414 in FIG. 4) between a request that triggered entropy checking and an action performed in response to the entropy checking. The action performed in response to the entropy checking can be a loading of an executable module, or a rejection of a request to load the executable module. The locking mechanism is provided to protect against a Time-of-Check-Time-of-Use (TOC-TOU) vulnerability. With the TOC-TOU vulnerability, an attacker can change the available address space in the time interval between the entropy check and loading of the executable module. For example, the attacker can wait until the OS loader 400 has determined that the number of available addresses satisfies the entropy condition, in response to which the attacker changes the number of available addresses, by consuming most of the available addresses. As a result, after the entropy check determines that the entropy condition has been satisfied, the attacker can change the number of available addresses such that the OS loader 400 would be forced to load the executable module at just one available address (or at one of a small number of available addresses).

The locking mechanism can be implemented by an OS, such as OS 220 in FIG. 4. In response to the load library request 402 or 408, the OS 220 when executed by a hardware processor(s) causes the hardware processor(s) to lock changes to the number of the available locations in the address space of the storage medium 102. Locking changes to the number of the available locations in the address space can include blocking an entity from making changes to the allocation of the address space.

Locking changes to the number of available locations effectively freezes the number of available locations prior to performing an entropy check. After the entropy check is completed and the OS loader 400 has either loaded (406) the executable module into a storage region of the storage medium 102, or the loader has rejected the request to load the executable module, the OS when executed by a hardware processor(s) causes the hardware processor(s) to trigger unlocking of the changes to the number of the available locations in the address space, at which point other requesters can load content to the available locations of the storage medium 102.

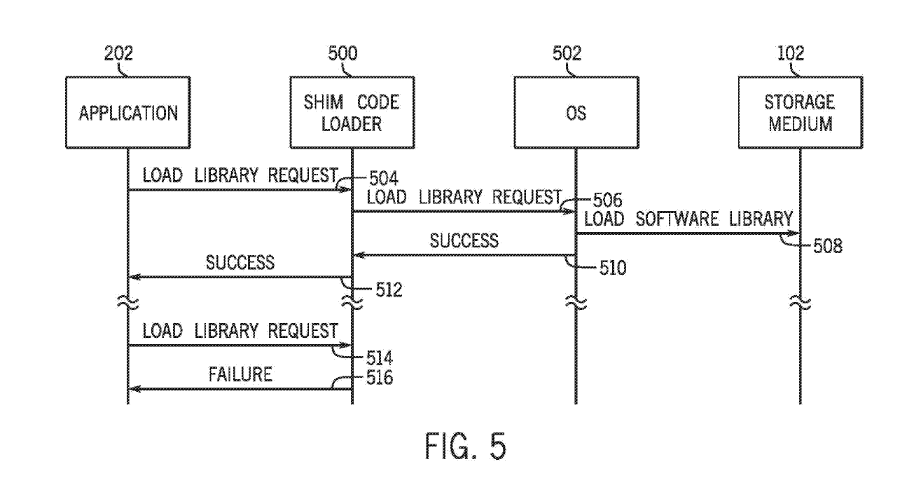

FIG. 5 is a message flow diagram of an example procedure in which a shim code loader 500 is used. The shim code loader 500 can be part of the loader engine 206 in FIG. 2. FIG. 5 also shows an OS 502.

The application 202 when executed by a hardware processor(s) causes the hardware processor(s) to submit a load library request (504) to the shim code loader 500. The shim code loader 500 when executed by a hardware processor(s) causes the hardware processor(s) to determine whether the number of available locations satisfies the entropy condition. If so, the shim code loader 500 when executed by a hardware processor(s) causes the hardware processor(s) to forward the load library request (506) to the OS 502, to cause a loader in the OS 502 to load (508) the requested software library to the storage medium 102. Upon successful loading of the requested software library, the OS 502 when executed by a hardware processor(s) causes the hardware processor(s) to return a success indication (510) to the shim code loader 500, which when executed by a hardware processor(s) causes the hardware processor(s) to forward the success indication (512) to the application 202.

In a different scenario, the application 202 when executed by a hardware processor(s) causes the hardware processor(s) to submit another load library request (514) to the shim code loader 500. In this case, the shim code loader 500 when executed by a hardware processor(s) causes the hardware processor(s) to determine that the number of available locations does not satisfy the entropy condition. As a result, the shim code loader 500 when executed by a hardware processor(s) causes the hardware processor(s) to send a failure indication (516) to the application 202. Note that the shim code loader 500 does not forward the load library request (514) to the OS 402, such that the requested software library is not loaded.

In implementations according to FIG. 5, a locking mechanism similar to that discussed above can be implemented by the shim code loader 500, instead of by the OS 502. In such implementations, instead of using the OS 502 to lock changes to the number of available locations in an address space, the shim code loader 500 when executed by a hardware processor(s) causes the hardware processor(s) to perform the locking by blocking accesses to the address space from other requesters.

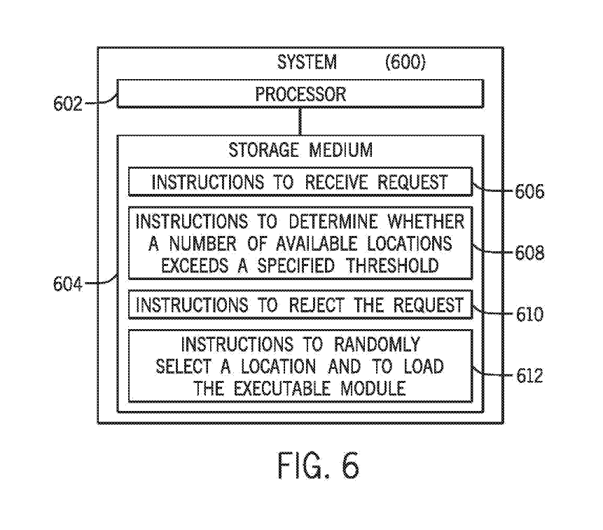

FIG. 6 is a block diagram of an example system 600 (which can include a computer or an arrangement of computers) according to some implementations. The system 600 includes one or multiple hardware processors 602 that is (are) coupled to a non-transitory machine-readable or computer-readable storage medium (or storage media) 604. The storage medium (or storage media) 604 can store machine-readable instructions that when executed by the hardware processor(s) 602 cause the hardware processor(s) 602 to perform specified tasks.

The machine-readable instructions can include instructions 606 to receive a request to load an executable module; instructions 608 to determine whether the number of available locations in an address space exceeds a specified threshold; instructions 610 to reject the request in response determining that the number of available locations in the address space does not exceed the specified threshold; and instructions 612 to randomly select a location from among the available locations and to load the executable module, in response to determining that the number of available locations in the address space exceeds the specified threshold.

The storage medium (or storage media) 604 can include one or multiple different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method of providing protected loading of a module, comprising:
receiving, by a system comprising a processor, a request to load the module; and
in response to the request:
determining, by the system, whether a number of available locations in an address space for randomized loading of the module exceeds a specified threshold; and
in response to determining that the number of available locations does not exceed the specified threshold, rejecting, by the system, the request to load the module.

2. The method of claim 1, wherein determining the number of the available locations comprises tracking the number of the available locations.

3. The method of claim 1, further comprising:
in response to determining that the number of available locations exceeds the specified threshold, randomly selecting, by the system, a location from among the available locations to load the module in response to the request.

4. The method of claim 3, wherein loading the module into the selected location comprises writing machine-readable instructions of the module into the selected location.

5. The method of claim 3, further comprising:
in response to the request, locking, by the system, changes to the number of available locations in the address space; and
triggering, by the system, unlocking of changes to the number of available locations in response to the rejecting or the loading of the module to the selected location.

6. The method of claim 5, wherein the locking prevents requesters from making changes to the number of available locations.

7. The method of claim 1, wherein the specified threshold varies for different requesters that request loading of modules to the address space.

8. The method of claim 1, wherein the request is received from a first requester, the method further comprising:
determining, by the system, whether entropy-based module loading is enabled for the first requester, wherein the determining of whether the number of available locations exceeds the specified threshold and the rejecting are performed in response to determining that entropy-based module loading is enabled for the first requester;
receiving, by the system, a second request from a second requester to load a second module; and
in response to the second request:
determining, by the system, whether entropy-based module loading is enabled for the second requester; and
in response to determining that entropy-based module loading is disabled for the second requester, deciding, by the system, to not determine whether a number of available locations exceeds the specified threshold for the loading of the second module.

9. The method of claim 8, further comprising:
setting, by the system, a first flag to a first value to enable entropy-based module loading for the first requester; and
setting, by the system, a second flag to a second value to disable entropy-based module loading for the second requester.

10. A system comprising:
a storage medium associated with an address space that includes addresses referring to respective locations in the storage medium; and
at least one processor to:
receive a request to load an executable module;
in response to the request, perform an entropy-based loading of the executable module into the address space, the entropy-based loading comprising:
determining whether a number of addresses available to load the executable module in the address space satisfies an entropy condition,
in response to determining that the number of addresses available to load the executable module satisfies the entropy condition, load the executable module at a selected address of the addresses available to load the executable module, and
in response to determining that the number of addresses available to load the executable module does not satisfy the entropy condition, reject the request.

11. The system of claim 10, wherein at least one processor is to:
in response to the request, cause blocking of changes to the address space; and
in response to the loading of the executable module or the rejecting, cause unblocking of the changes to the address space.

12. The system of claim 11, wherein the at least one processor is to execute an operating system to perform the entropy-based loading and the blocking.

13. The system of claim 11, wherein the at feast one processor is to execute application code to perform the entropy-based loading and the blocking.

14. The system of claim 10, wherein the entropy condition is satisfied responsive to the number of the addresses available to load the executable module exceeding a specified threshold, and the entropy condition is not satisfied responsive to the number of the addresses available to load the executable module not exceeding the specified threshold.

15. An article comprising at least one non-transitory machine-readable storage medium storing instructions to provide protected loading of a module, the instructions upon execution cause a system to:
receive a request to load the module; and
in response to the request:
determine whether a number of available locations in an address space for randomized loading of the module exceeds a specified threshold;
in response to determining that the number of available locations does not exceed the specified threshold, reject the request to load the module; and
in response to determining that the number of available locations exceeds the specified threshold, randomly select a location from among the available locations in the address space, and load the module into the selected location.
